(19) United States
(12) Patent Application Publication
(10) Pub. No.: US 2014/0047967 A1
(43) Pub. Date: Feb. 20, 2014

(54) Saw Base for Providing Straight And Bevel Cuts Having A Common Cut Line

(71) Applicant: Dino Makropoulos, Edison, NJ (US)

(72) Inventor: Dino Makropoulos, Edison, NJ (US)

(21) Appl. No.: 13/942,697

(22) Filed: Jul. 15, 2013

Related U.S. Application Data
(60) Provisional application No. 61/671,739, filed on Jul. 15, 2012.

(51) Int. Cl. B23D 59/00; B26D 7/00

(52) U.S. Cl. CPC B23D 59/007; B26D 7/0006
USPC 83/829; 83/821

(57) ABSTRACT

A saw base assembly for use with a saw support apparatus. The saw base assembly allows for any power tool, cutting device, drill, and associated bits of various sizes to be utilized to make straight and bevel saw cuts having a common cut line. The saw base assembly includes a first guide rail and a second guide rail, a fixed plate coupled to the first and second guide rails, a moveable plate coupled to the first and second guide rails, a means for securing the fixed plate and the moveable plate to the guide rails, and a means for securing the saw base assembly to the saw support apparatus.

### I. RELATED APPLICATIONS

This application claims priority to U.S. Provisional Patent Application No. 61/671,739, filed on Jul. 15, 2012 and entitled, “Saw Base for Providing Straight and Bevel Cuts Having a Common Cut Line”; the entire contents of which are incorporated herein by reference.

### II. TECHNICAL FIELD OF THE INVENTION

Example embodiments of the invention are directed to a saw base that can make straight and bevel saw cuts that have a common cut line, and more particular, to a saw base that enables quick and easy straight and bevel cutting capabilities for universal edge guide cutting (UEG).

### III. BACKGROUND OF THE INVENTION

Various types of power tool guides have been developed for use with circular saws and routers. Circular saws are useful for making straight cuts and angled or bevel cuts on a variety of materials including wood. Circular saws typically have a pivoting mechanism that allows the angle of the saw blade to be adjusted relative to the saw base and set to a desired cutting angle.

Unfortunately, during the cutting process, if the saw blade is changed to a different size or the circular saw is changed to a different saw, it is very difficult to maintain the same common cutting line. Conventional power tool guides are designed for use with specific power tools limiting flexibility of the user to make multiple types of desired cuts.

### IV. SUMMARY OF THE INVENTION

One example embodiment provides a saw base assembly for use with a saw support apparatus. The saw base assembly includes a pair of guide rails. A fixed plate is coupled to the guide rails and a moveable plate is also coupled to the guide rails. Means for securing the fixed plate and the moveable plate to the guide rails are provided. Means for securing the saw base assembly to the saw support apparatus are provided.

### V. BRIEF DESCRIPTION OF THE DRAWINGS

FIG. 1A illustrates a rear perspective view of an example saw base assembly being used to make a straight cut according to example embodiments;

FIG. 1B illustrates a rear perspective view of an example saw base assembly being used to make a bevel cut according to example embodiments;

FIG. 2A illustrates a perspective view of a moveable plate according to example embodiments;

FIG. 2B illustrates a side view of the moveable plate of FIG. 2A;

FIG. 2C illustrates a perspective view of a fixed plate according to example embodiments;

FIG. 2D illustrates a side view of the fixed plate of FIG. 2C;

FIG. 3A illustrates a top perspective view of an example saw base assembly according to example embodiments;

FIG. 3B illustrates a bottom perspective view of the saw base assembly of FIG. 3A;

FIG. 3C illustrates a top view of the saw base assembly of FIG. 3A;

FIG. 3D illustrates a bottom view of the saw base assembly of FIG. 3A;

FIG. 3E illustrates a front view of the saw base assembly of FIG. 3A;

FIG. 3F illustrates a rear view of the saw base assembly of FIG. 3A;

FIG. 3G illustrates a left side view of the saw base assembly of FIG. 3A;

FIG. 3H illustrates a right side view of the saw base assembly of FIG. 3A;

FIG. 4A illustrates a bottom perspective view of a sliding fence according to example embodiments;

FIG. 4B illustrates a bottom perspective view of the sliding fence of FIG. 4A mounted to a saw base assembly according to example embodiments;

FIG. 5A illustrates a top perspective view of an example saw base assembly mounted to a universal edge guide (UEG) according to example embodiments;

FIG. 5B illustrates a side view of an example saw base assembly mounted to a universal edge guide (UEG) according to example embodiments;

FIG. 5C illustrates another side view of an example saw base assembly mounted to a universal edge guide (UEG) according to example embodiments;

FIG. 6A illustrates a rear perspective view of an example power saw mounted to the saw base assembly according to example embodiments;

FIG. 6B illustrates a front perspective view of an example power saw mounted to the saw base assembly according to example embodiments;

FIG. 6C illustrates a bottom perspective view of an example power saw mounted to the saw base assembly according to example embodiments;

FIG. 6D illustrates a rear perspective view of a pivot mechanism, in accordance to one embodiment of the present invention;

FIG. 6E illustrates a side elevational view of an example power tool mounted to a saw base assembly, in accordance to one embodiment of the present invention;

FIG. 6F illustrates a perspective view of a moveable plate, in accordance to one embodiment of the present invention;

FIG. 6G illustrates a side elevational view of the moveable plate of FIG. 6F;

FIG. 6H is a perspective view of a locking device, in accordance to one embodiment of the present invention;

FIG. 6I illustrates a partial, right rear view of a guide track, in accordance to one embodiment of the present invention;

FIG. 6J illustrates partial, magnified perspective view of the guide track of FIG. 6I;

FIG. 7A illustrates a rear perspective view of the saw base assembly and power saw mounted to the UEG according to example embodiments;

FIG. 7B illustrates a bottom perspective view of the saw base assembly and power saw mounted to the UEG according to example embodiments;

FIG. 7C illustrates a right side view of the saw base assembly and power saw mounted to the UEG according to example embodiments;

FIG. 7D illustrates a left side view of the saw base assembly and power saw mounted to the UEG according to example embodiments;

FIG. 7E illustrates a front view of the saw base assembly and power saw mounted to the UEG according to example embodiments;

FIG. 7F illustrates a rear view of the saw base assembly and power saw mounted to the UEG according to example embodiments;

FIG. 8A is a partial cross-sectional view illustrating the saw base assembly and power saw making a straight cut on a piece of material, in accordance to one embodiment of the present invention;

FIG. 8B is a partial cross-sectional view illustrating a combined image of the saw base assembly and power saw making a straight cut and a bevel cut on a piece of material, in accordance to one embodiment of the present invention; and

FIG. 8C is a partial cross-sectional view illustrating the saw base assembly and power saw making a bevel cut on a piece of material, in accordance to one embodiment of the present invention.

### VI. DETAILED DESCRIPTION OF THE INVENTION

It will be readily understood that the components of the present invention, as generally described and illustrated in the figures herein, may be arranged and designed in a wide variety of different configurations. Thus, the following detailed description of the embodiments of an apparatus and system, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present invention. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

Example embodiments provide an affordable saw base assembly for providing straight and bevel cuts with high accuracy. The saw base assembly may be used in conjunction with a saw support apparatus such as a universal edge guide (UEG) saw configuration. The saw base assembly uses guide rails, a fixed plate and a moveable plate to make straight and bevel cuts having a common cut line. A power tool, such as a rotary saw, is positioned on the moveable plate. The fixed plate and the moveable plate are coupled to the guide rails and the UEG. In operation, as a user pivots the saw blade to change the angle of the bevel cut, the moveable plate moves or displaces both the plate and the power tool toward or away from the fixed plate to maintain a common cut line for all desired cutting angles.

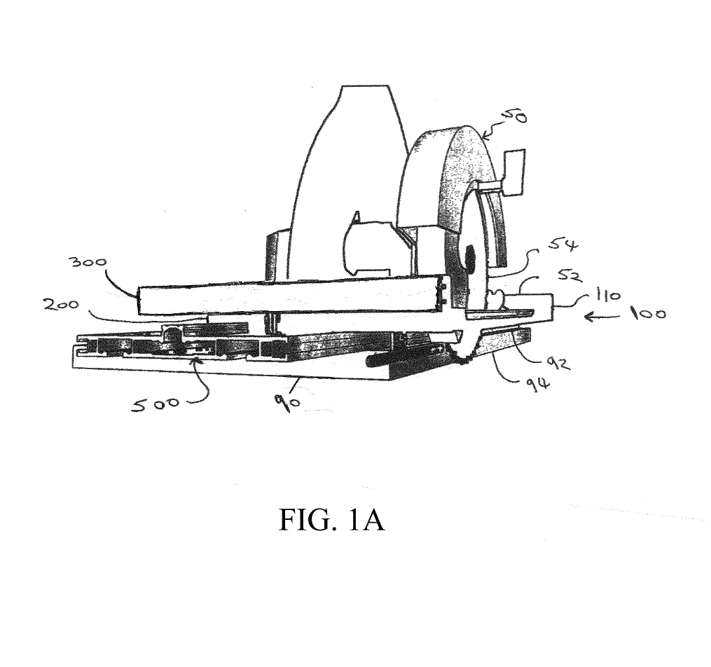

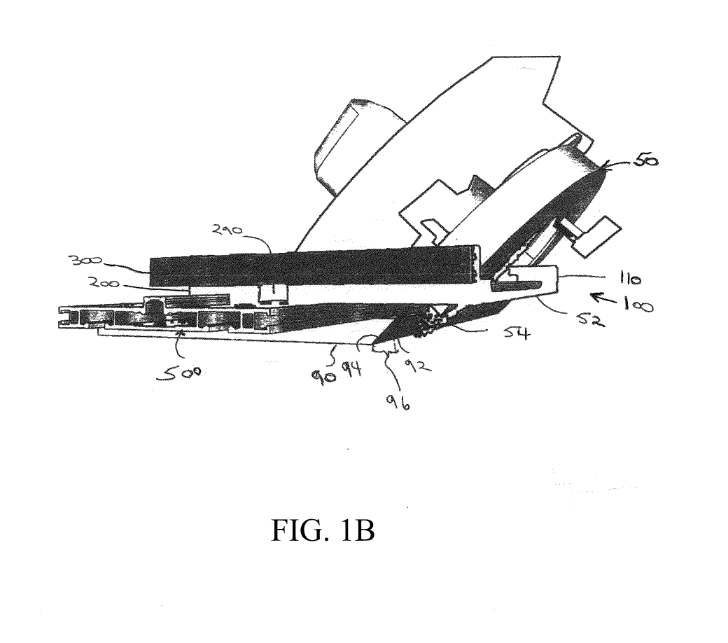

FIG. 1A illustrates a rear perspective view of an example saw base assembly being used to make a straight cut. Referring to FIG. 1A, the saw base assembly 100 includes a moveable plate 110, a fixed plate 200, and a guide rail assembly 300. A power saw or tool 50 rests on moveable plate 110. Power tool 50 can include a variety of power tools, drills and associated bits, such as including, but not limited to a rotary saw, saber saw, router, shifting saw, or drill. Power tool 50 has a tool base 52 and a circular saw blade 54. Tool base 52 rests on moveable plate 110. Saw base assembly 100 is coupled to and supported by a guided saw support device 500, or more specifically a UEG, which may be slidably adjusted to move the power saw 50 into a desired position for cutting material 90 to be cut.

The power saw 50 is held in a particular cutting position by saw base assembly 100. Material 90 can be any suitable material to be cut such as wood or plastic. Material 90 has an upper cut edge 92 and a lower cut edge 94. In FIG. 1A, power saw 50 is illustrated making a straight cut on material 90 with saw blade 54 perpendicular to the plane of material 90. The guided saw support device 500 (UEG) is described in and published under the PCT as International Publication No. WO 2012/047736 A2, which is hereby incorporated herein by reference in its entirety.

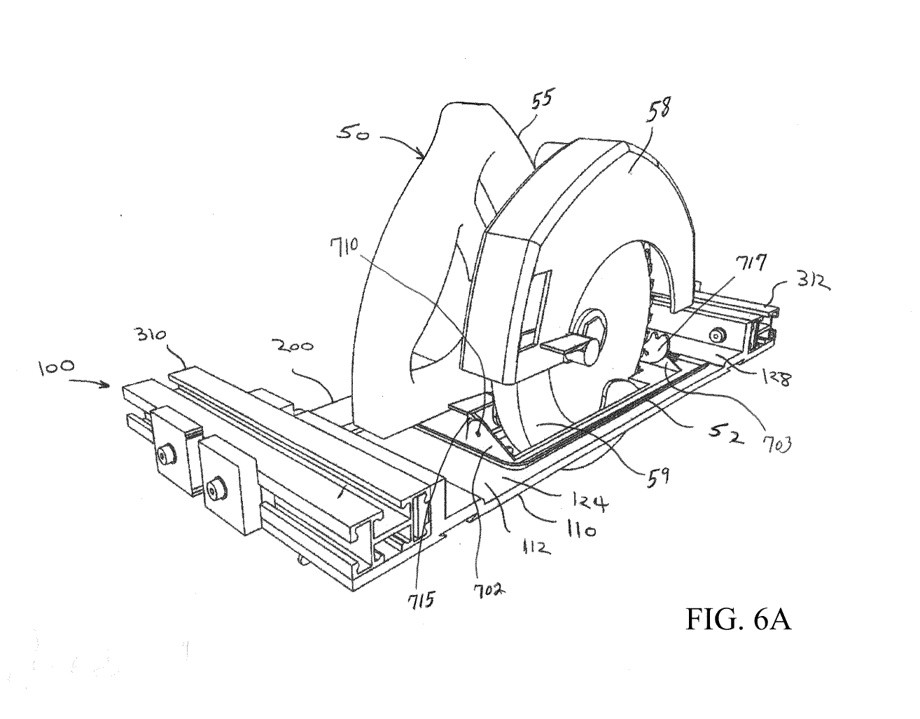

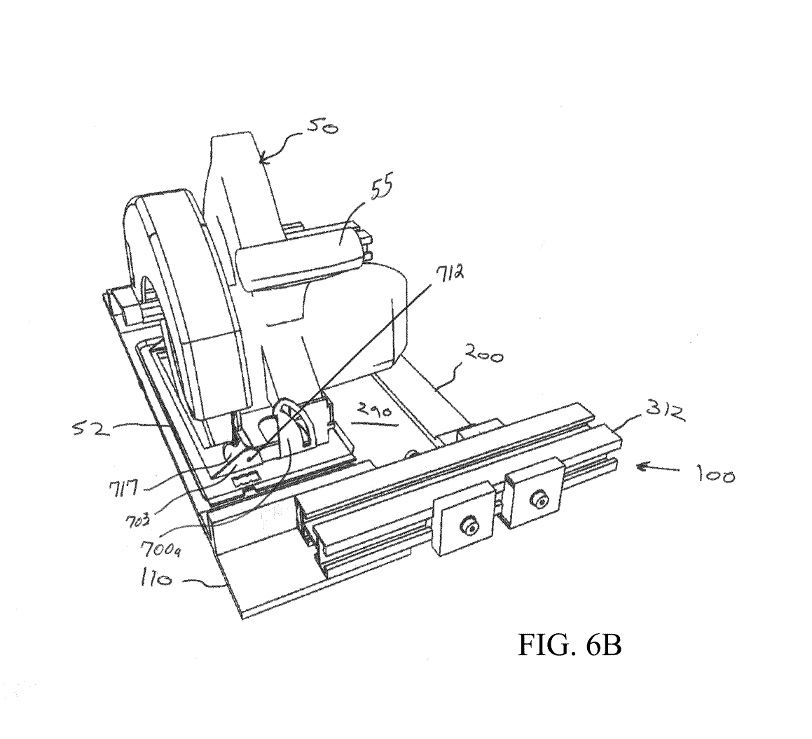

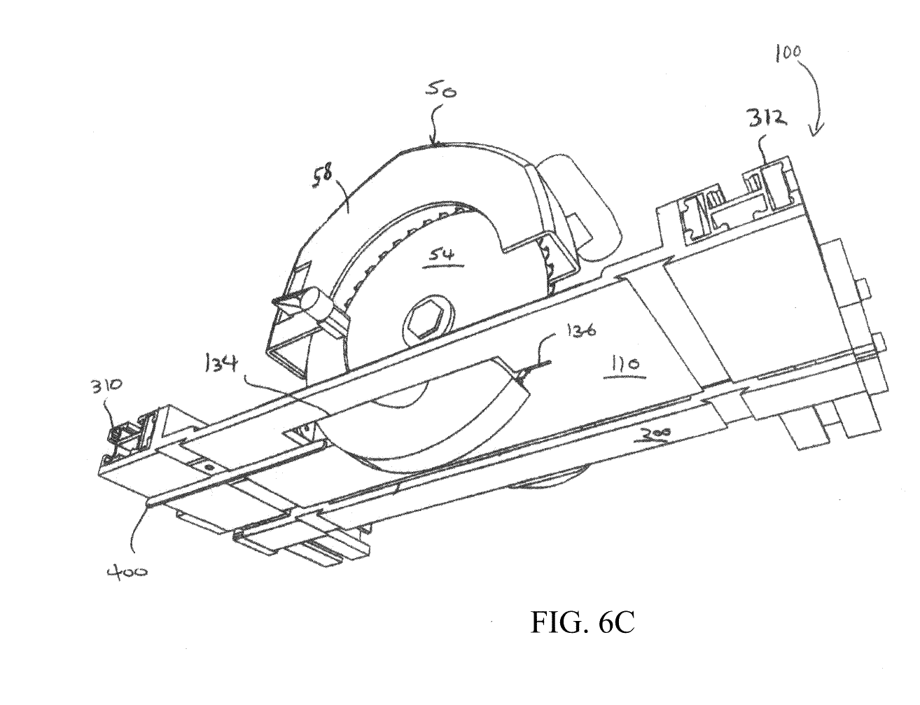

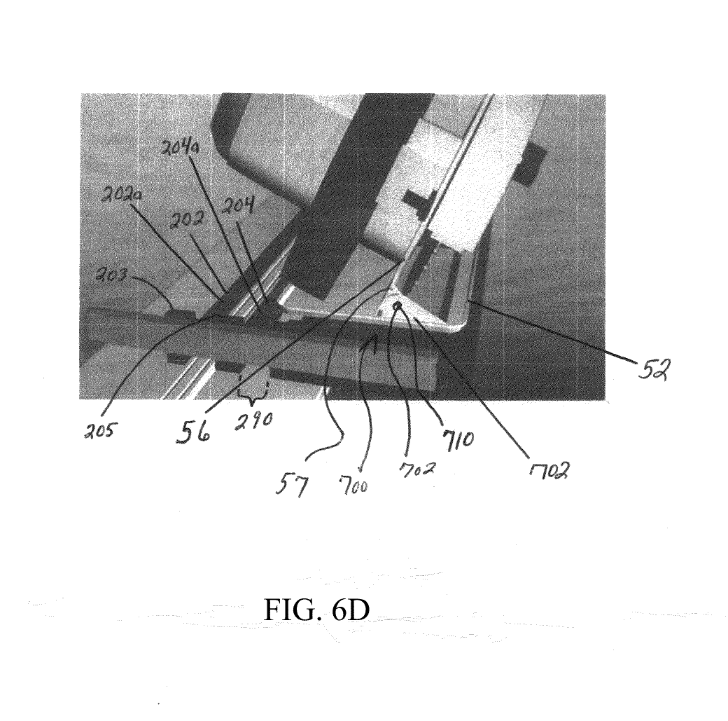

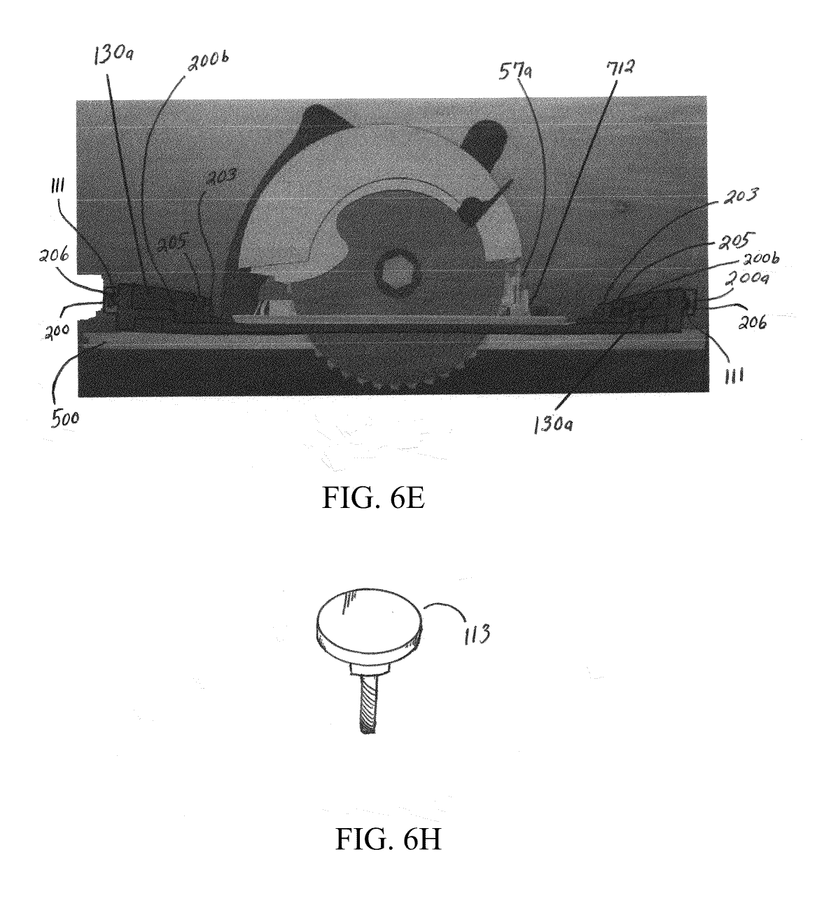

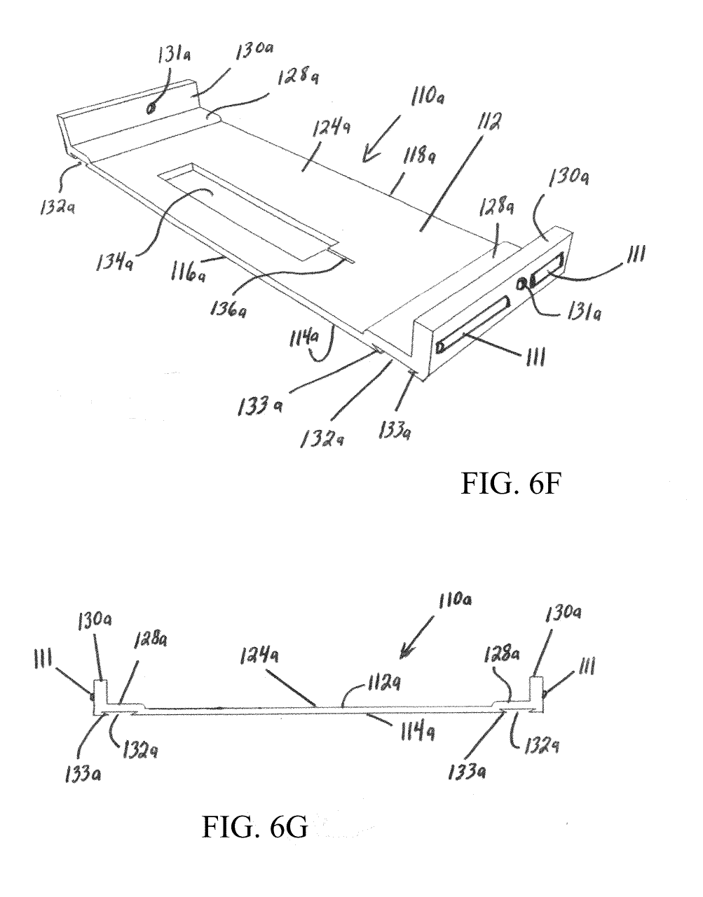

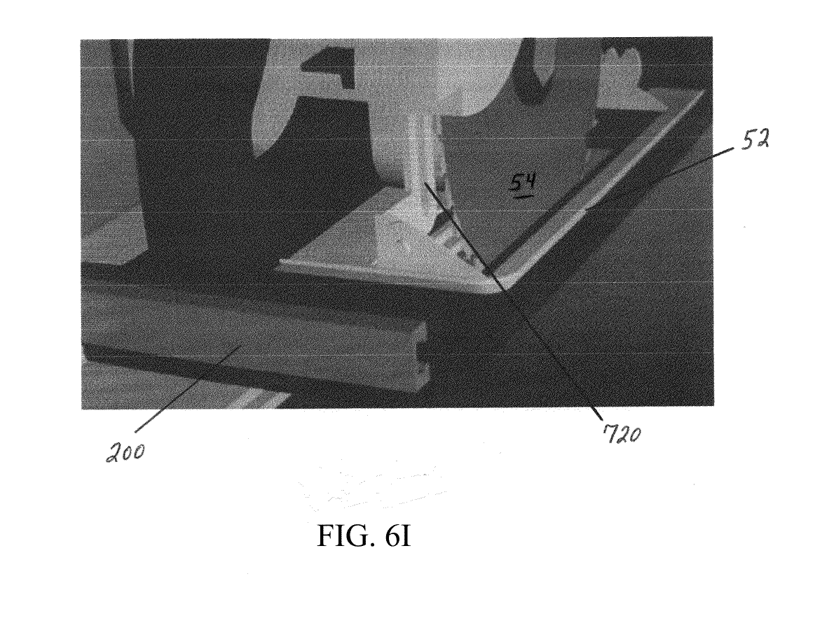

FIG. 1B illustrates a rear perspective view of saw base assembly 100 being used to make a bevel or angled cut. Referring to FIG. 1B, saw blade 54 has been pivoted relative to tool base 52 such that the angle between saw blade 54 and material 90 is greater than ninety degrees. Power saw 50 and saw blade 54 are pivotally adjustable about a pivot axis 702 via a pivot mechanism 700, as best shown in FIGS. 6A, 6B, and 6D; the pivot mechanism 700. In accordance to one embodiment, the pivot mechanism 700 comprises a pair of ears 702, 703 upwardly extending integrally from the tool base 52 about opposed upper peripheral side edges thereof, the ears 702, 703 each having a hinge pin receiving aperture defined therethrough, the hinge pin receiving apertures being axially aligned with one another. A planar protective blade guard 56 of power saw 50 includes integrally molded arm extensions 57, 57a projecting perpendicularly therefrom, the arm extensions 57, 57a each having a corresponding hinge pin receiving aperture defined therethrough, the corresponding hinge pin receiving apertures being axially aligned with one another. A pair of hinge pins 710, 712 are pivotally received in the hinge pin receiving apertures of ears 702, 703 and corresponding hinge pin receiving apertures of arm extensions 57, 57a of planar protective blade guard 56, thereby pivotally securing power saw about the periphery of tool base 52, and allowing power saw 50 to be pivotally adjustable about pivot axis 702.

In accordance to another pivot mechanism 700 embodiment which may be employed by other various power saw 50 tools or devices, the ears 702, 703 of tool base 52 may be pivotally secured, respectively, to opposing arm extensions 715, 717 of a blade plate tilt or pivot mechanism 700a, shown in FIGS. 6A and 6B.

As power saw 50 is pivoted, moveable plate 110 slides along guide rails assembly 300 away from fixed plate 200 creating a gap 290 between moveable plate 110 and fixed plate 200. The movement of moveable plate 110 also causes power saw to move away from fixed plate 200. Power saw 50 is now offset from fixed plate 200 by a horizontal distance 96 between the upper cut edge 92 and the lower cut edge 94. The horizontal distance 96 between the upper cut edge 92 and the lower cut edge 94 corresponds to the width of gap 290. The use of saw base assembly 100 allows displacement of power saw 50 to occur when making bevel cuts such that lower cut edge 94 has the same cut line for any angle bevel cut or for a straight cut.

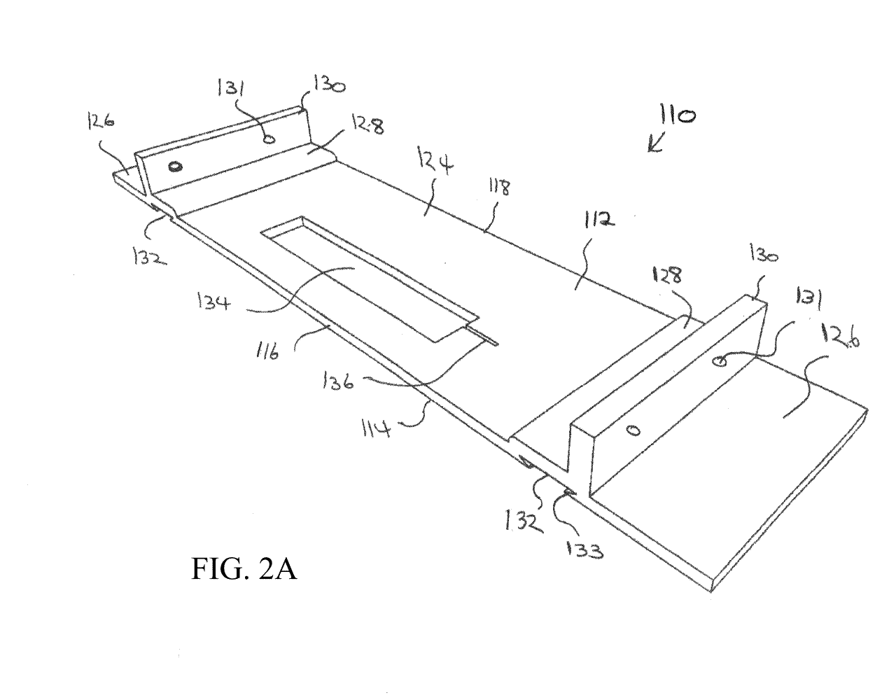

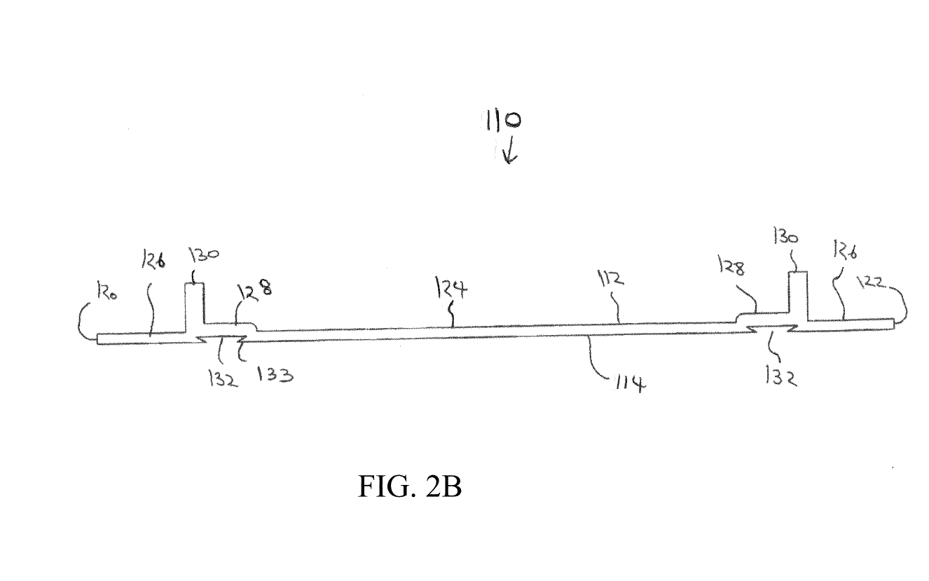

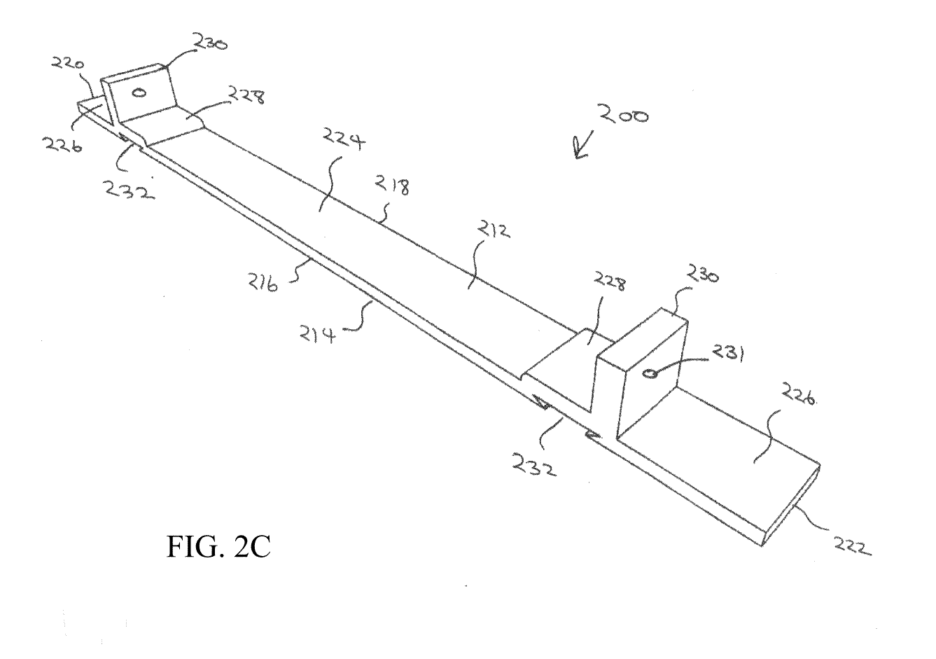

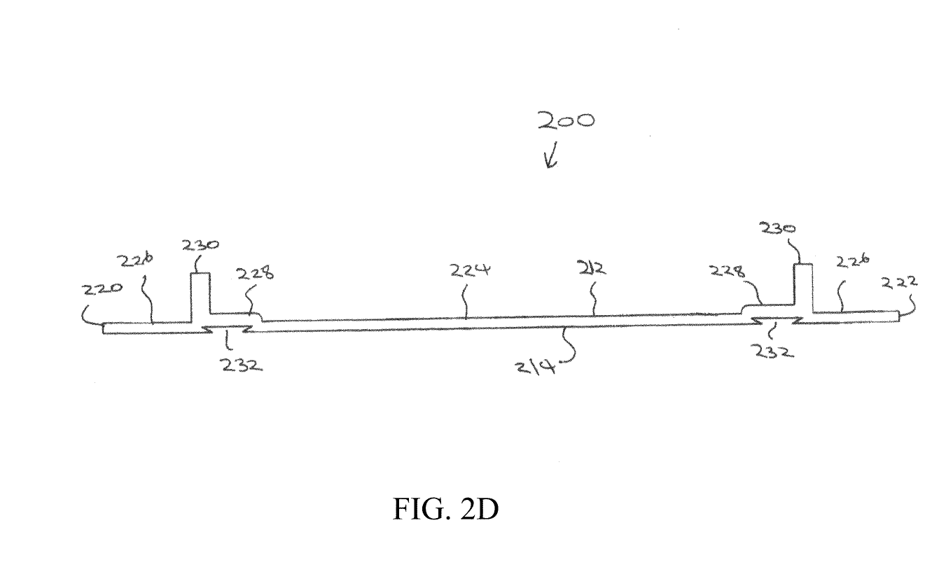

FIGS. 2A and 2B illustrate perspective and side views, respectively of an example moveable plate 110 according to example embodiments. Referring to FIGS. 2A and 2B, moveable plate 110 is generally planar and rectangular in shape and includes a top surface 112 and a bottom surface 114. Moveable plate 110 has long sides 116, 118 and short sides 120, 122. Moveable plate 110 includes a center section 124 and a pair of outer sections or wings 126 that are located on opposite sides of and extend away from center section 124. Outer wings 126 are co-planar with center section 124. A pair of opposed spaced apart shoulders 128 are defined in top surface 112 on opposite sides of center section 124. A pair of opposed spaced apart rectangular shaped walls 130 extend perpendicularly upward from top surface 112 on opposite sides of center section 124 and between shoulders 128 and outer wings 126. A pair of apertures 131 extend perpendicularly through each of walls 130. A pair of trapezoidal shaped slots 132 are defined in bottom surface 114 below shoulders 128. Slots 132 extend between sides 116 and 118 and are partially defined by a pair of opposed generally triangular elongated flukes 133 that extend into slots 132. A rectangular shaped saw blade opening 134 is defined in center section 124 towards side 116. A groove 136 is defined in center section 124 and extends away from one edge of saw blade opening 134.

FIGS. 2C and 2D illustrate perspective and side views, respectively of an example fixed plate 200 according to example embodiments. Referring to FIGS. 2C and 2D, fixed plate 200 is generally planar and rectangular in shape and includes a top surface 212 and a bottom surface 214. Fixed plate 200 has long sides 216, 218 and short sides 220, 222. Fixed plate 200 includes a center section 124 and a pair of outer sections or wings 226 that are located on opposite sides of and extend away from center section 224. Outer wings 226 are co-planar with center section 224. A pair of opposed spaced apart shoulders 228 are defined in top surface 212 on opposite sides of center section 224. A pair of opposed spaced apart rectangular shaped walls 230 extend perpendicularly upward from top surface 212 on opposite sides of center section 224 and between shoulders 228 and outer wings 226. An aperture 231 extends perpendicularly through each of walls 230. A pair of trapezoidal shaped slots 232 are defined in bottom surface 214 below shoulders 228. Slots 232 extend between sides 216 and 218. Moveable plate 110 and fixed plate 200 can be formed from a suitable material such as extruded aluminum or plastic.

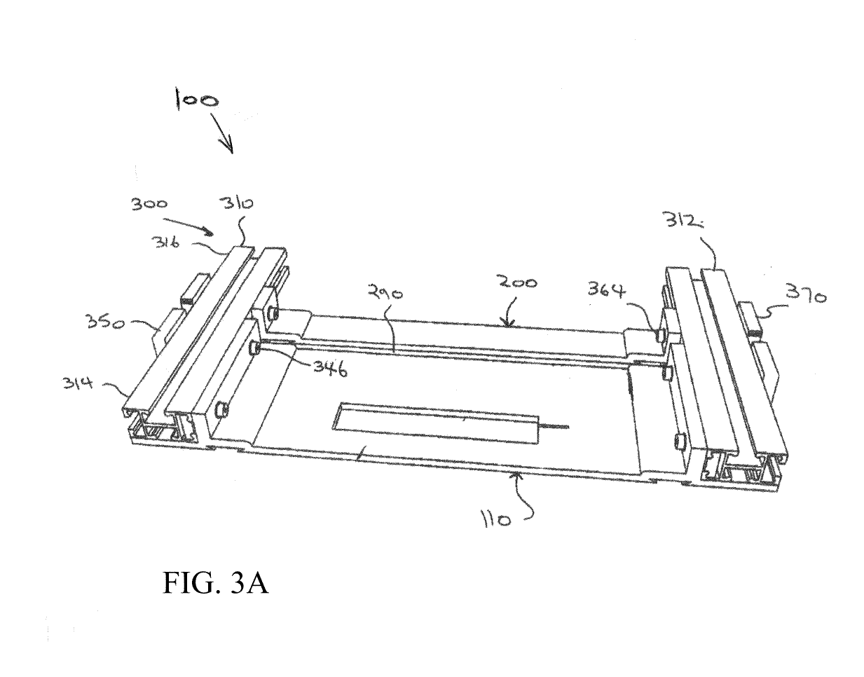

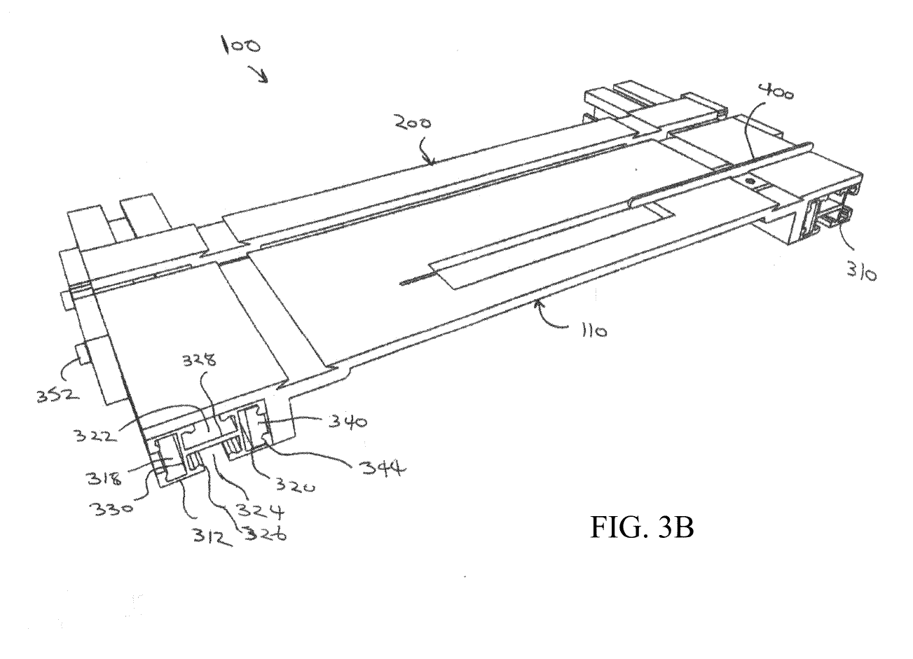

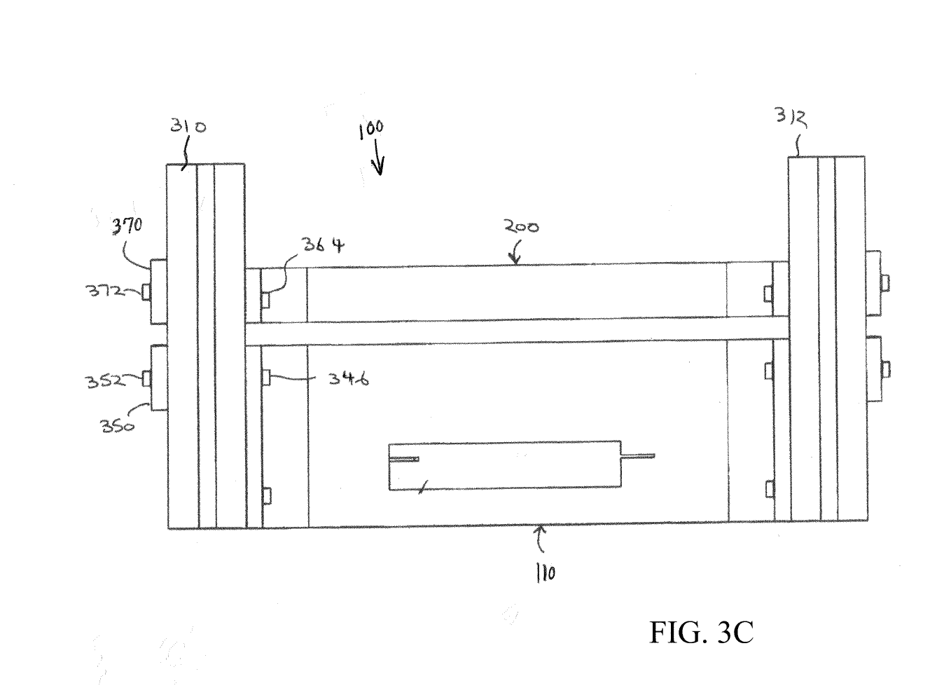

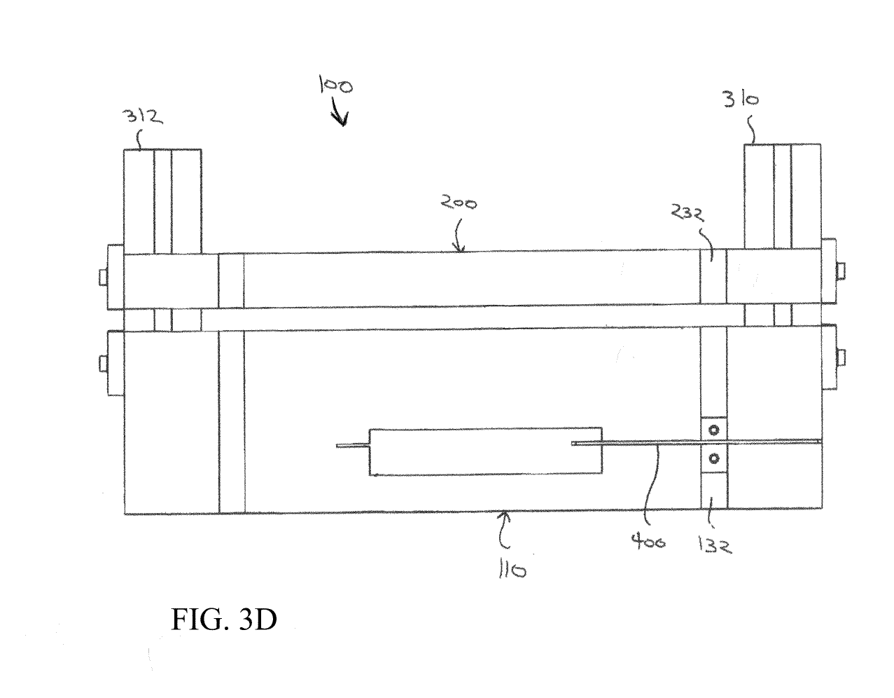

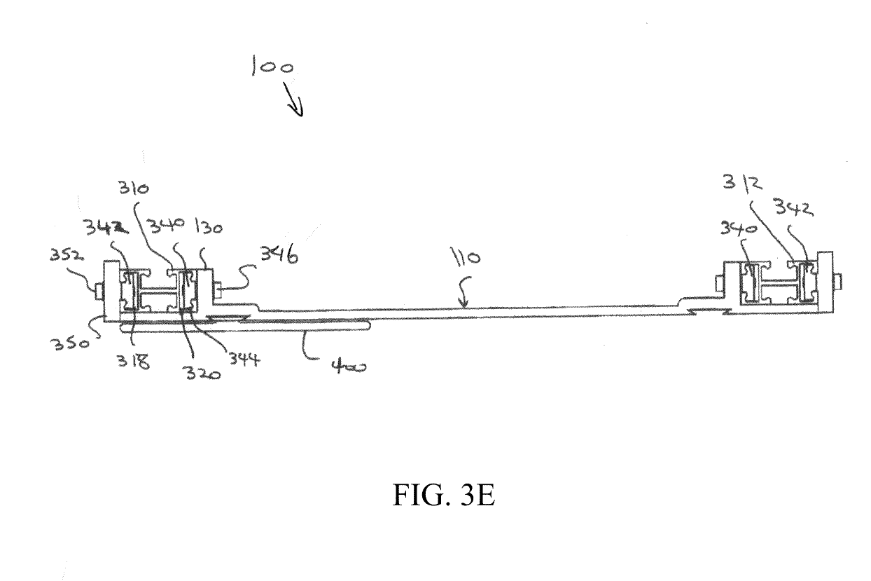

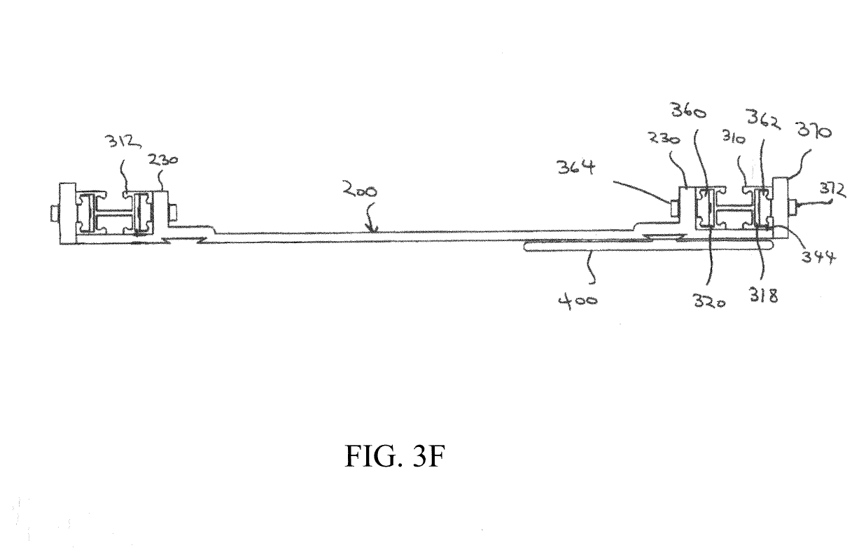

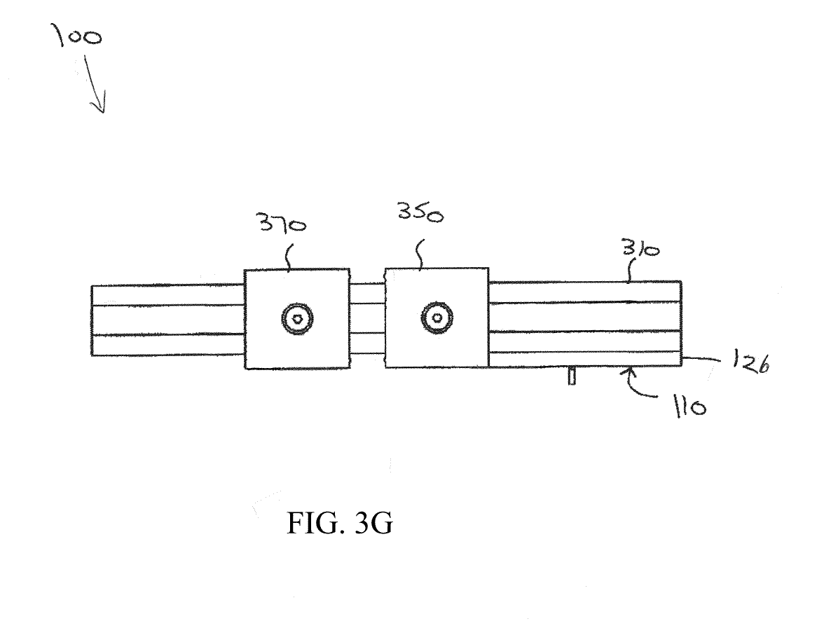

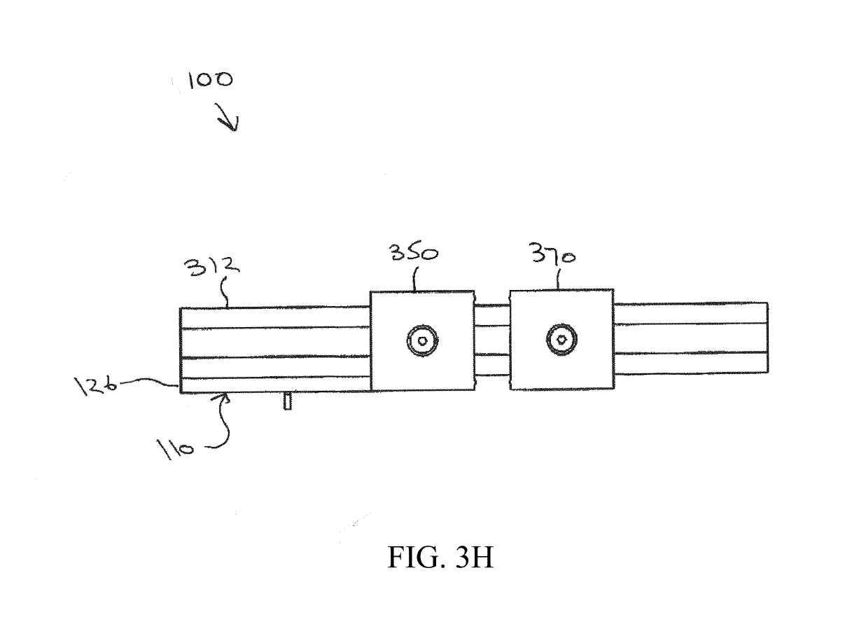

FIGS. 3A-3H illustrate a saw base assembly 100 according to example embodiments. Moveable plate 110 and fixed plate 200 are supported by and coupled to a sliding mechanism 300. Sliding mechanism 300 comprises a pair of spaced apart generally horizontally oriented elongated guide rails 310 and 312. Guide rails 310 and 312 are oriented parallel with plate walls 130 and 230 and have a generally H-shaped cross-section. Guide rails 310 and 312 have ends 314 and 316 respectively, Each of guide rails 310 and 312 define four channels 318, 320, 322 and 324 that extend the length of guide rails 310 and 312. Channels 318 and 320 are diametrically opposed and channels 322 and 324 are diametrically opposed. Each channel 318, 320, 322 and 324 is at least partially defined by a pair of ridges or lip 326 that extend along each of the channels the entire length of guide rails 310 and 312. A center support member 328 divides channels 322 and 324 and a pair of upright walls 330 are joined to the ends of center support member 328 and divides channel 318 from 320. Guide rails 310 and 312 can be formed from extruded aluminum or plastic.

With specific reference to FIG. 3E, a front view of saw base assembly 100 is shown. An elongated support beam 340 is slidably mounted in each guide rail channel 320 and a support shoe 342 is slidably mounted in each guide rail channel 318. Support beams 340 and support shoes 342 each have two alignment features 344 that can extend over and mate with lip 326. Support beams 340 are located adjacent to an outer surface of walls 130. Moveable plate 110 is mounted below guide rails 310 and 312 such that wings 126 (FIG. 2A) extend under guide rails 310 and 312. Threaded fasteners 344 can be used to slidably retain moveable plate 110 to guide rails 310 and 312. External threads on fasteners 346 mate with internal threads on apertures (not shown) in support beam 340. When fasteners 344 are loosened, moveable plate 110 and support beams 344 can slide within channel 320 relative to guide rails 310 and 312. When fasteners 346 are tightened, moveable plate 110 and support beams 344 are fixed to guide rails 310 and 312.

A square shaped moveable block 350 is located adjacent to each of channels 318 and an outer surface of guide rails 310 and 312. Threaded fasteners 352 can be used to slidably retain moveable blocks 350 to guide rails 310 and 312, the threaded fasteners 352 comprise turnable knobs. External threads on fasteners 352 mate with internal threads on apertures (not shown) in support shoes 342. When fasteners 352 are loosened, moveable blocks 350 and support shoes 342 can slide within channel 318 relative to guide rails 310 and 312. When fasteners 352 are tightened, moveable blocks 350 and support shoes 342 are fixed to guide rails 310 and 312.

With specific reference to FIG. 3F, a rear view of saw base assembly 100 is shown. An elongated support beam 360 is slidably mounted in each guide rail channel 320 and a support shoe 362 is slidably mounted in each guide rail channel 318. Support beams 360 and support shoes 362 each have two alignment features 344 that can extend over and mate with lip 326. Support beams 360 are located adjacent to an outer surface of walls 230. Fixed plate 200 is mounted below guide rails 310 and 312 such that wings 226 (FIG. 2C) extend under guide rails 310 and 312. Threaded fasteners 364 can be used to slidably retain fixed plate 200 to guide rails 310 and 312. External threads on fasteners 364 mate with internal threads on apertures (not shown) in support beam 360. When fasteners 364 are loosened, fixed plate 200 and support beams 360 can slide within channel 320 relative to guide rails 310 and 312. When fasteners 364 are tightened, fixed plate 200 and support beams 360 are fixed to guide rails 310 and 312.

A square shaped fixed block 370 is located adjacent to each of channels 318 and an outer surface of guide rails 310 and 312. Threaded fasteners 372 can be used to slidably retain fixed blocks 370 to guide rails 310 and 312, the threaded fasteners 352 comprise turnable knobs. External threads on fasteners 372 mate with internal threads on apertures (not shown) in support shoes 362. When fasteners 372 are loosened, fixed blocks 370 and support shoes 362 can slide within channel 318 relative to guide rails 310 and 312. When fasteners 372 are tightened, fixed blocks 370 and support shoes 362 are fixed to guide rails 310 and 312.

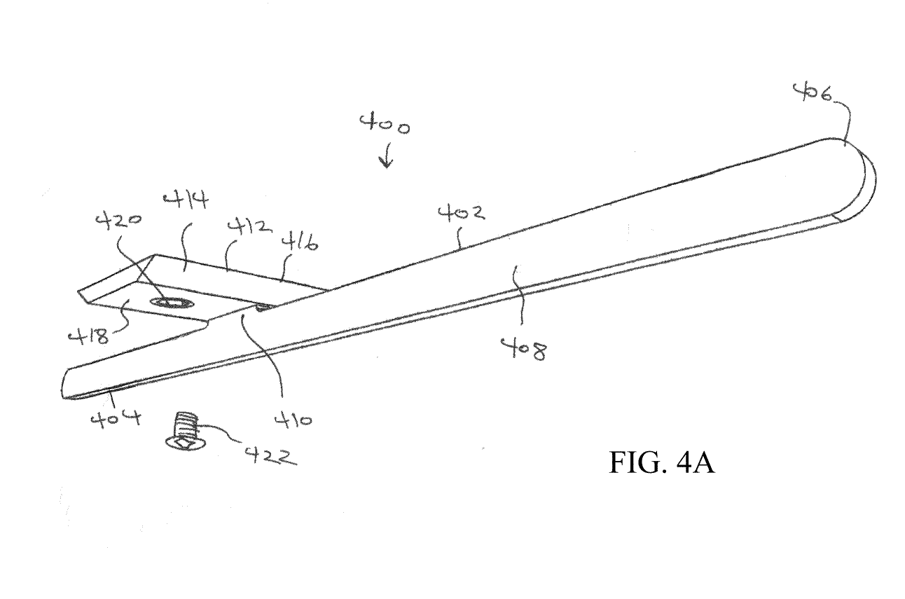

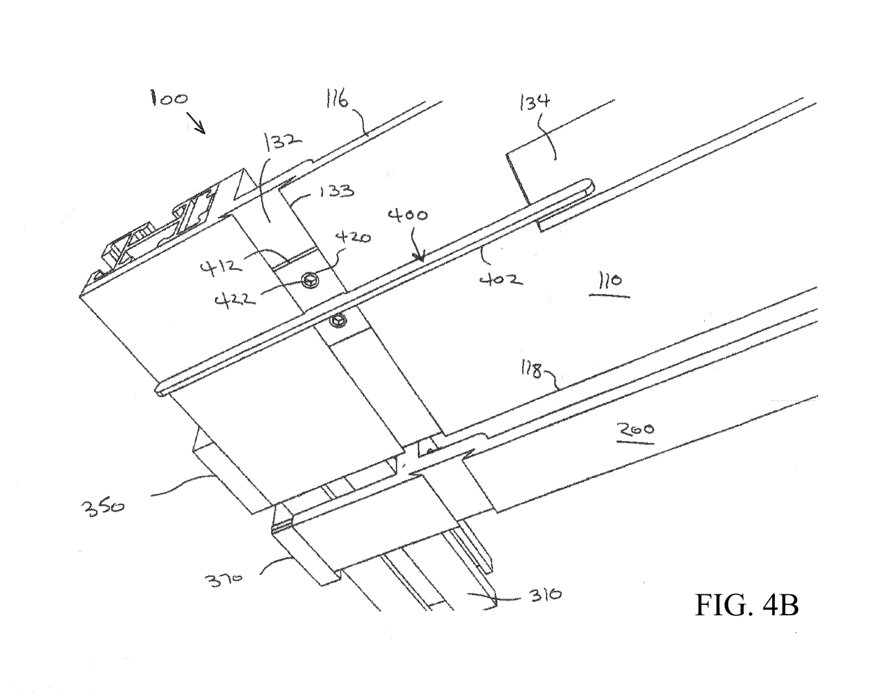

FIG. 4A illustrates a bottom perspective view of a sliding fence 400 according to example embodiments. Sliding fence 400 comprises an elongated blade 402 that has rounded ends 404 and 406. A post 410 extends from one side of blade 402 and supports a generally rectangular shaped mounting bar 412. Mounting bar 412 includes a top side 416, bottom side 418 and four angled side surfaces 414. A pair of threaded apertures 420 extends through mounting bar 412 between top side 416 and bottom side 418. Threaded apertures 420 can receive set screws 422.

FIG. 4B illustrates a bottom perspective view of the sliding fence 400 mounted to saw base assembly 100 according to example embodiments. Sliding fence 400 is retained to moveable plate 110 by mounting bar 412 being affixed in slot 132. Mounting bar 412 can be slid into slot 132 with angled surfaces 414 retained in slot 132 by juxtaposed fluxes 133. Sliding fence 400 can slide within slot 132 between ends 116 and 118. Sliding fence 400 can be fixed to moveable plate 110 through the use of set screws 422. Set screws 422 can be threaded into apertures 420 until the ends of set screws 422 contact the bottom of channel 132 thereby retaining sliding fence 400 to moveable plate 110.

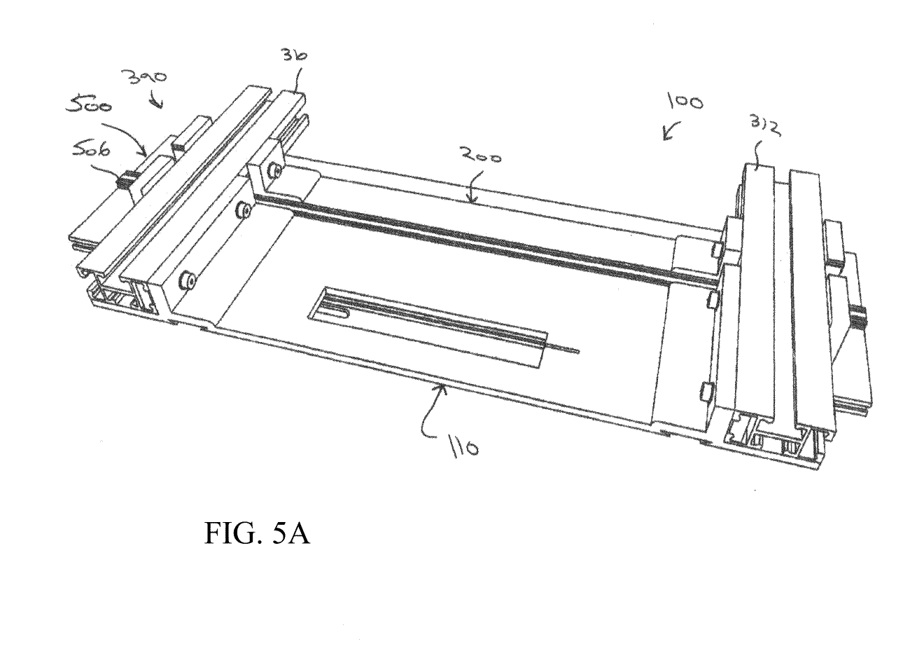

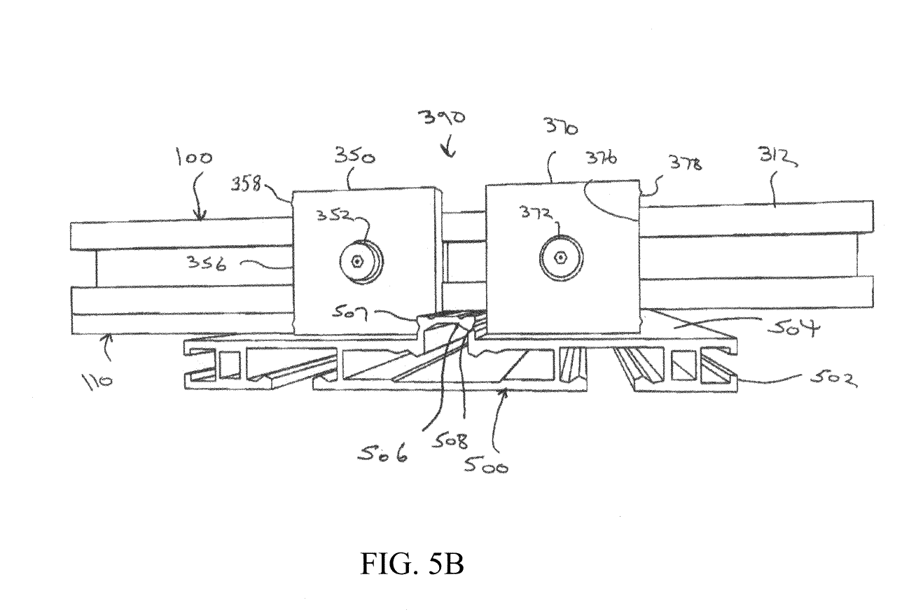

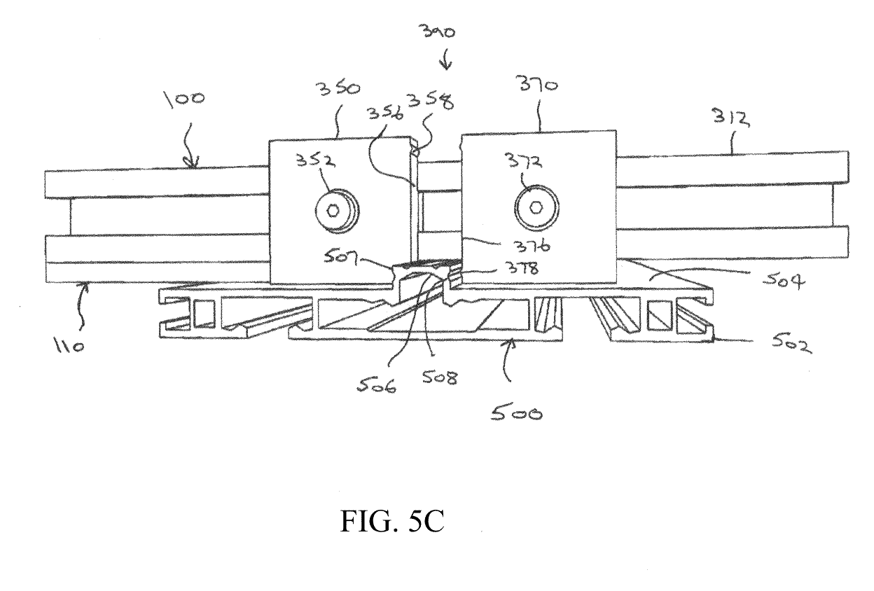

FIGS. 5A and 5B illustrate an example saw base assembly 100 mounted to a saw support apparatus or universal edge guide (UEG) 500 according to example embodiments. UEG 500 includes an elongated guide plate 502 that has a top surface 504. A guide track 506 extends perpendicularly from top surface 504 along the length of guide plate 502. Guide track 506 has opposed sides 507. Flutes 508 are defined in each side 507 and extend the length of guide track 506.

Saw base assembly 100 is coupled to UEG 500 by a retaining mechanism 390. Retaining mechanism 390 comprises a blocks 350, 370, fasteners 352, 372 and guide track 506, wherein fasteners 352, 372 may comprise turnable knobs. Saw base assembly 100 is placed over UEG 500 such that guide track 506 is located between blocks 350 and 370 and one side of blocks 350 and 370 are supported by top surface 504. Blocks 350 and 370 can be adjusted using fasteners 352 and 372 to be in contact with sides 507. Saw base assembly 100 can slide along the length of guide track 506. In FIG. 5B, saw base assembly 100 is shown in a configuration that allows saw base assembly 100 to be freely lifted off and removed from UEG 500. Blocks 350 include four side surfaces 356 and blocks 370 include four side surfaces 376. Blocks 350 and 370 are rotated such that a smooth side surface 376 is located adjacent to guide track sides 507.

In FIG. 5C, saw base assembly 100 is shown in a configuration where saw base assembly 100 is slidably retained to UEG 500. Blocks 350 further include four side surfaces 356. A pair of fingers 358 extends away from one of side surfaces 356. Blocks 370 further include four side surfaces 376. A pair of fingers 378 extends away from one of side surfaces 376. Blocks 350 and 370 are rotated such that fingers 358 and 378 are retained in flukes 508 thereby retaining saw base assembly 100 to UEG 500 while at the same time allowing saw base assembly 100 to slide along guide track 506.

FIGS. 6A-6C illustrate perspective views of an example power tool or saw 50 for use with saw base assembly 100 according to example embodiments. Saw base assembly 100 secures and guides the power saw 50 along the material 90 (FIG. 1A) to be cut during a cutting operation. Power saw 50 has a tool base 52 or shoe, a circular saw blade 54, an upper blade guard 58 and a retracting lower blade guard 59. Power saw 50 can be placed on moveable plate 110 with tool base 52 resting on top surface 112 in center section 124 and the front of power saw 50 facing guide rail 312. Moveable plate 110 holds power saw 50, and wherein power saw 50 may alternatively be releasably secured to moveable plate 110 via suitable fasteners. In this position, the front edge of tool base 52 abuts front shoulder 128 and blade guard 58 extends through saw blade opening 134. Power saw can also be placed on moveable plate 110 in the reverse direction (not shown) with tool base 52 resting on top surface 112 in center section 124 and the front of power saw 50 facing guide rail 310.

In accordance to one embodiment, and in particular reference to FIGS. 6D-6J, the saw base assembly 100 includes a moveable plate 110a, a pair of horizontally-oriented fixed plates 200, 200a and a guide rail assembly 300. The saw base assembly 100 is shown coupled to and supported by a guided saw support device 500, or more specifically, the UEG 500. The fixed plates 200, 200a each comprises a pair of opposed spaced apart support walls 202, 204, the support walls 202, 204 each includes an elongated base 202a, 204a having outer ends 203, 205, respectively, which extend perpendicularly upward therefrom. The fixed plates 200, 200a each further comprises an elongated channel 206 formed along an inner surface thereof and extending a length theredown. The movable plate 110a is generally planar and rectangular in shape and includes a top surface 112a, a bottom surface 114a, and long sides 116a, 118a. Moveable plate 110a further includes a center section 124a and a pair of opposed spaced apart shoulders 128a, the pair of spaced apart shoulders 128a is integrally defined in top surface 112a on opposite sides of center section 124a. The outer ends of the pair of shoulders 128a terminate into a pair of opposed spaced apart rectangular shaped walls 130a which integrally extend perpendicularly upward from an upper surface of the pair of opposed spaced apart shoulders 128a. At least one aperture or threaded aperture 131a extends perpendicularly through each of walls 130a. A pair of slots 132a is defined in bottom surface 114a below shoulders 128a and walls 130a. The slots 132a are shown herein as having a trapezoidal shape. Slots 132a extend between sides 116 and 118 and are partially defined by a pair of opposed generally triangular elongated flukes 133a that extend into slots 132a. A rectangular shaped saw blade opening 134a is defined in center section 124a towards side 116a. A groove 136a is defined in center section 124a and extends away from one edge of saw blade opening 134a. The movable plate 110a further comprises an elongated rib 111 protruding integrally from a rear surface of each the pair of opposed spaced apart rectangular shaped walls 130a thereof, wherein the ribs 111 engage and slidably translate about the channels 206, respectively, of fixed plates 200, 200a.

During a sawing operation where it is desirable to releasably secure moveable plate 110a to fixed plates 200, 200a in a temporary fixedly-secured relationship, a locking means 113, such as a threaded bolt with handle may be utilized. The threaded bolt threadedly engages the at least one threaded aperture 131a by turning the handle thereof in one direction until the lower end of bolt extends through each of the pair of opposed spaced apart rectangular shaped walls 130a and threadedly engages a complementary threaded opening 200b formed in each the fixed plates 200, 200a, and firmly contacting fixed plates 200, 200a, thereby detachably securing moveable plate 110a to fixed plates 200, 200a. The locking device 113 may be defined as a gland, or a sliding holder. To enable slidable translation of moveable plate 110a about fixed plates 200, 200a, the handle portion of locking device 113 is turned in the opposite direction, thereby removing contact by bolt end with fixed plates 200, 200a.

In further accordance to this particular embodiment, moveable plate 110 is slidably translated about fixed plates 200, 200a in a direction away from support wall 204, creating a gap 290 between support wall 204 and moveable plate 110a (as best illustrated in FIG. 6D). Power saw 50 is next pivoted clockwise about pivot axis 702, and is slidably moved downward along a guide track 720. The guide track 720 is formed integral to the protective blade guard 56 as an elongated slot 722. A guide pin 724 engages the elongated slot 722 so as to allow the power saw 50 to slidably translate longitudinally about the guide track 720. Guide pin 724 may be releasably locked about a desired longitudinal position along elongated slot 722 via a tightening or turning device 726, such as a knob, disposed on guide pin 724. The saw base assembly 100, moveable plate 110a, fixed plates 200, 200a, pivot mechanism 700, and guide track 720 allow for: a) any angle bevel cut or straight cut to be made, and b) a same cut line to be made using any power tool 50, such as including but not limited to a rotary power saw, saber saw, router, shifting saw, and drill. In addition, the saw base assembly 100, moveable plate 110a, fixed plates 200, 200a, pivot mechanism 700, and guide track 720 further allow for the same cut line to be made irrespective of changing or using a saw blade 54 with a different thickness than used in a first cutting event; operator will obtain the same cut line in the second cutting event as was made during the first cutting event although a saw blade of a different thickness was used in second cutting event. Thus, the present invention functions to maintain a common cut line for all desired cutting angles.

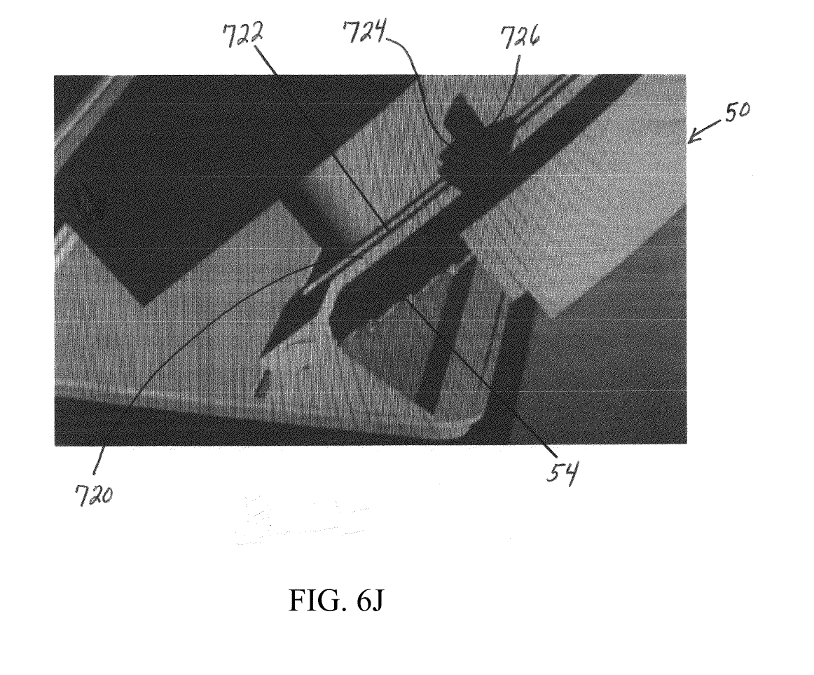

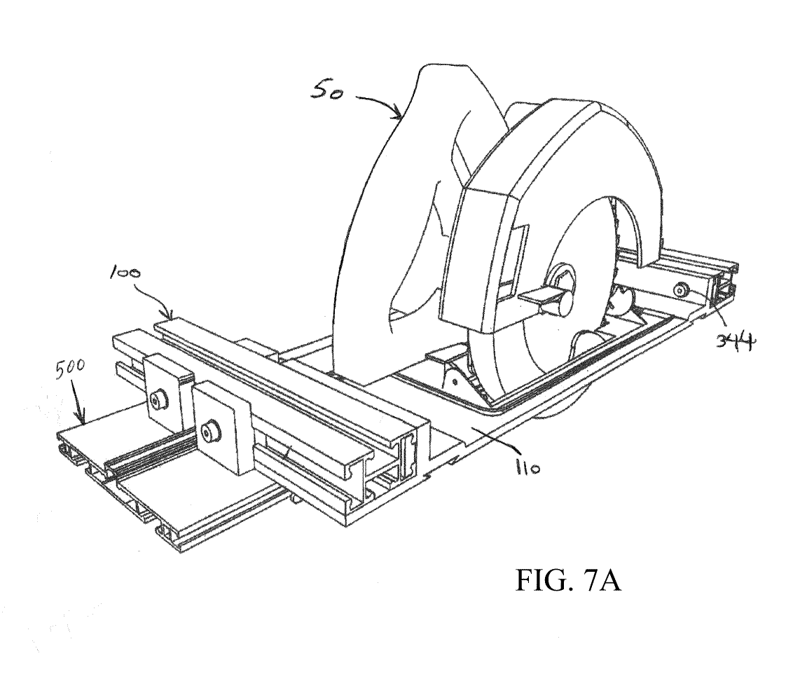

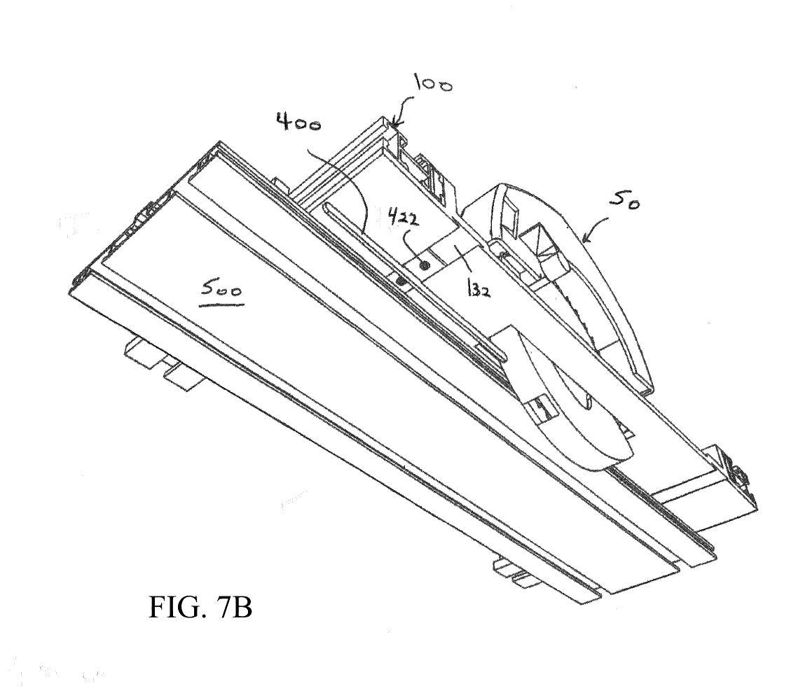

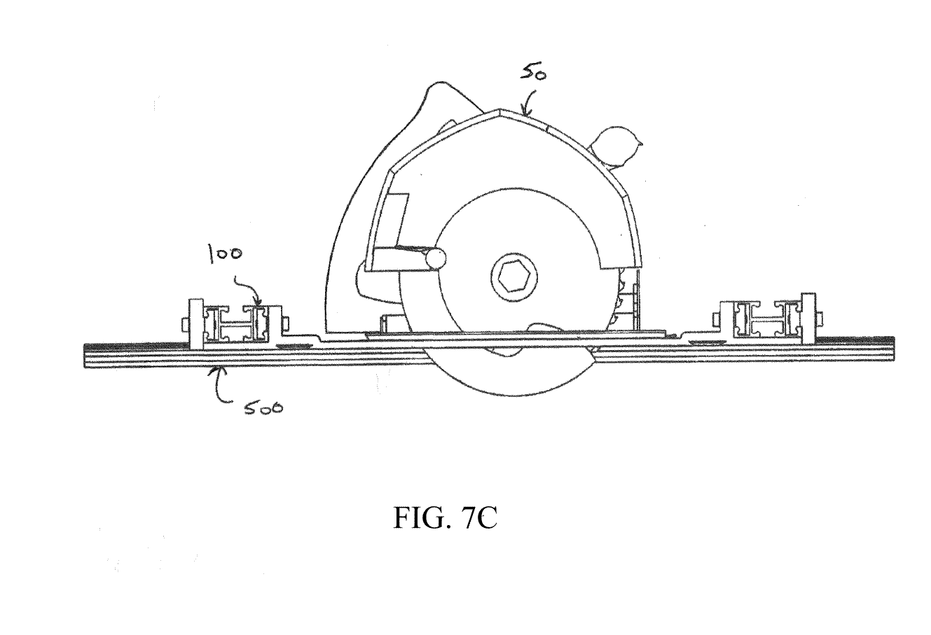

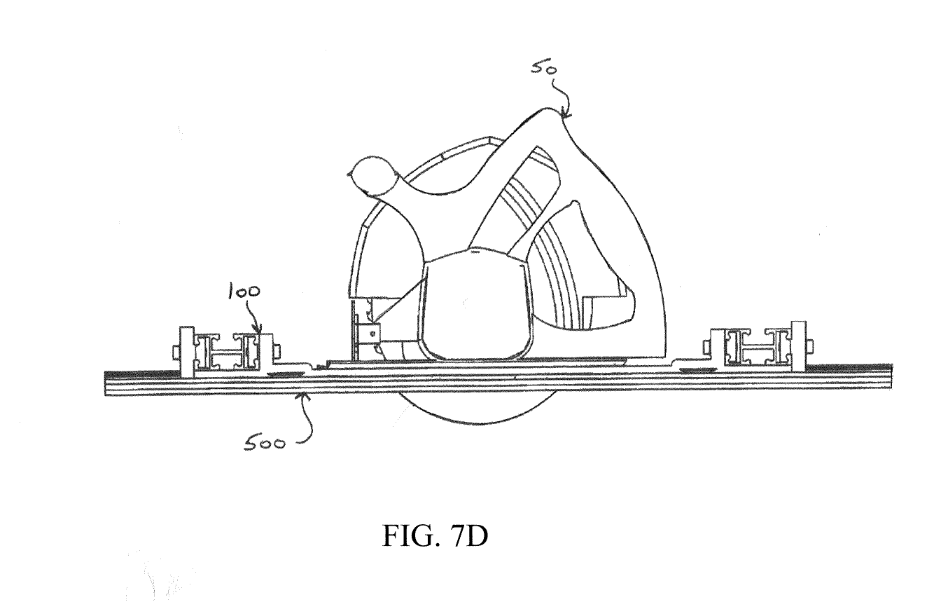

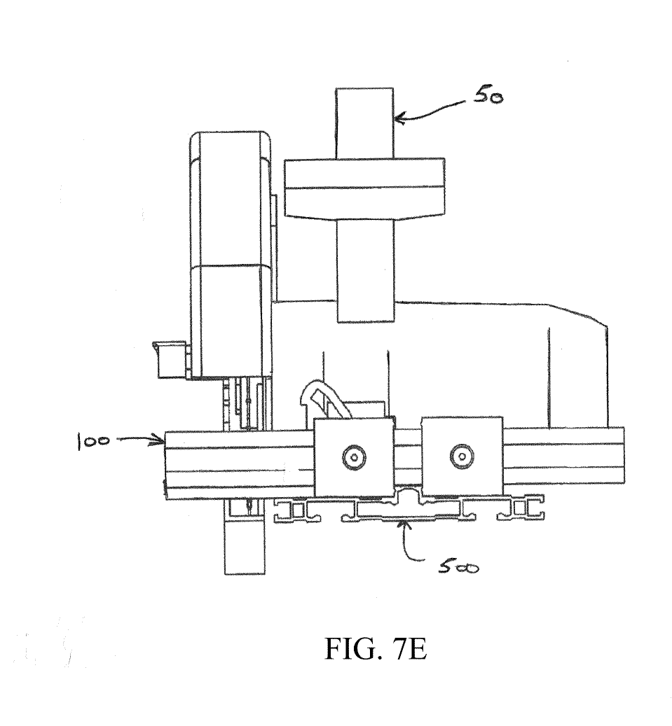

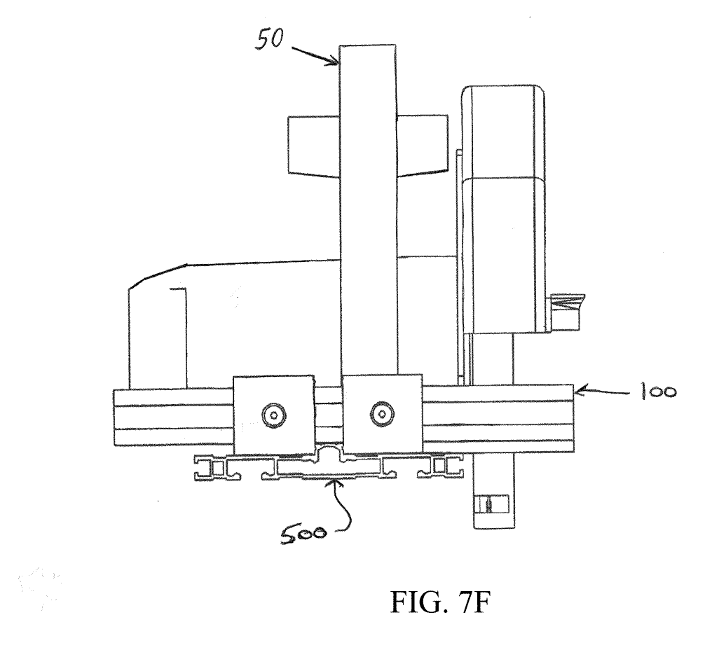

FIGS. 7A-7F illustrate views of the saw base assembly and power saw mounted to the UEG according to example embodiments. Saw base assembly 100 and UEG 500 secure and guide the power saw 50 along the material 90 (FIG. 1A) to be cut during a cutting operation. Power saw 50 is coupled to moveable plate 110 as previously described in FIGS. 6A-6C and saw base assembly 100 is coupled to UEG 500 as previously described in FIGS. 5A-5C.

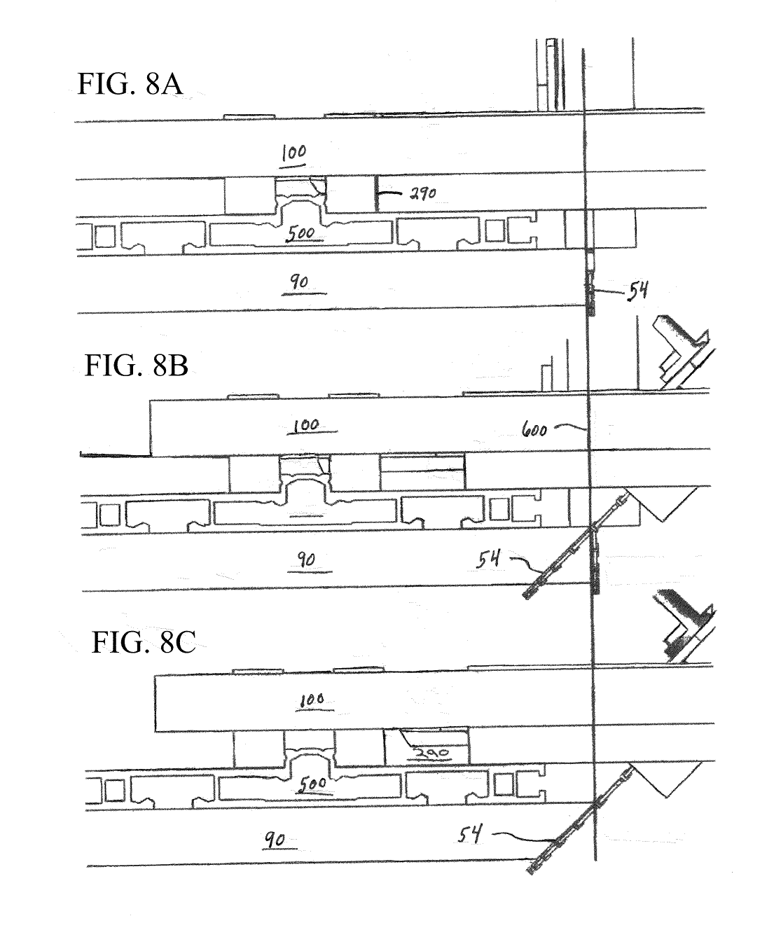

FIG. 8A is a partial cross-sectional view illustrating the saw base assembly and power saw making a straight cut on a piece of material, in accordance to one embodiment of the present invention. With additional reference to FIGS. 7A and 7B, saw base assembly 100 can be used be used to make a straight or ninety degree cut in the following manner. Fasteners 344 are loosened allowing moveable plate 110 to be moved along guide rails 310 and 312 adjacent to fixed plate 200 such that gap 290 is minimal. Fasteners 344 are then tightened causing moveable plate 110 to be fixed in position to guide rails 310 and 312. Sliding fence 400 is then moved along slot 132 and fixed in position using set screws 432. Next, retaining mechanism 390 is set by rotating and securing blocks 350 and 370 in order to retain saw base assembly 100 to UEG 500. Power saw 50 can now be started and manually moved by a user along the longitudinal axis of UEG 500 causing a corresponding movement of saw base assembly 100 along the longitudinal axis of UEG 500. As power saw 50 moves, saw blade 54 engages material 90 thereby creating a straight cut.

FIG. 8C is a partial cross-sectional view illustrating the saw base assembly and power saw making a bevel cut on a piece of material, in accordance to one embodiment of the present invention. With additional reference to FIGS. 7A and 7B, saw base assembly 100 can be used be used to make a bevel or angled cut in the following manner. Fasteners 344 are loosened allowing moveable plate 110 to be moved along guide rails 310 and 312 away from fixed plate 200 such that gap 290 is has a dimension. Fasteners 344 are then tightened causing moveable plate 110 to be fixed in position to guide rails 310 and 312. Sliding fence 400 is then moved along slot 132 and fixed in position using set screws 432. Next, retaining mechanism 390 is set by rotating and securing blocks 350 and 370 in order to retain saw base assembly 100 to UEG 500. Power saw 50 can now be started and manually moved by a user along the longitudinal axis of UEG 500 causing a corresponding movement of saw base assembly 100 along the longitudinal axis of UEG 500. As power saw 50 moves, saw blade 54 engages material 90 thereby creating a bevel cut.

FIG. 8B is a partial cross-sectional view illustrating a combined image of the saw base assembly and power saw making a straight cut and a bevel cut on a piece of material, in accordance to one embodiment of the present invention. FIG. 8B illustrates saw base assembly 100 providing a common cut line 600 for both straight cuts and angled cuts.

In accordance to another embodiment of the present invention, the power saw, tool, or drill 50 may be shifted or moved, e.g., in a left and right direction, instead of shifting or moving the saw base assembly 100 or moveable plate 110, thereby allowing for straight and bevel saw cuts having a common cut line to be made independent to or without requiring the saw base assembly 100 or moveable plate 110 to be moved or operatively engaged.

In accordance to yet another embodiment of the present invention, means is provided for shifting or moving the power saw, tool, or drill 50, e.g., in a left and right direction, instead of shifting or moving the saw base assembly 100 or moveable plate 110, thereby allowing for straight and bevel saw cuts having a common cut line to be made independent to or without requiring the saw base assembly 100 or moveable plate 110 to be moved or operatively engaged.

The present invention enables the ability to maintain the same cutting line for any guide track and any power saw and any saw blade thickness. The present invention can be used in forward and reverse directions and with various types of circular saws and routers. Saw base assembly 100 allows bevel cuts to be made and allows straight line cuts to be made without any loss in cutting line precision.

While preferred embodiments of the present invention have been described, it is to be understood that the embodiments described are illustrative only and the scope of the invention is to be defined solely by the appended claims when considered with a full range of equivalents, and modifications (e.g., protocols, hardware devices, software platforms etc.) thereto.

What is claimed is:

1. A saw base assembly for use with a saw support apparatus, the saw base assembly comprising:
a first guide rail and a second guide rail;
a fixed plate coupled to the first and second guide rails;
a moveable plate coupled to the first and second guide rails;
means for securing the fixed plate and the moveable plate to the guide rails; and
means for securing the saw base assembly to the saw support apparatus.

2. A saw base assembly comprising:
a pair of fixed plates; and
a moveable plate, the moveable plate is detachably securable to the pair of fixed plates, the moveable plate supports a power tool base, the tool base supporting a power tool.

3. The saw base assembly of claim 2, wherein the pair of fixed plates is spatially oriented, the moveable plate being detachably secured between the pair of fixed plates.

4. The saw base assembly of claim 2, wherein the pair of fixed plates being detachably coupled to a UEG via suitable fasteners or retaining mechanisms.

5. The saw base assembly of claim 3, wherein the moveable plate is slidably adjustable.

6. The saw base assembly of claim 5, wherein the moveable plate slidably translates about the pair of fixed plates.

7. The saw base assembly of claim 2, wherein the moveable plate having the power tool base detachably coupled thereto via suitable fasteners or retaining mechanisms.

8. The saw base assembly of claim 2, wherein the moveable plate supporting the power tool base, the power tool base comprising a pivot mechanism.

9. The saw base assembly of claim 8, wherein the moveable plate supporting the power tool base, the power tool base comprising a guide track.

10. The saw base assembly of claim 8, wherein the power tool base supporting the power tool, the power tool being pivotally adjustable about the pivot mechanism.

11. The saw base assembly of claim 10, wherein the power tool slidably translates longitudinally about the guide track.
